(19) United States
(12) Patent Application Publication
(10) Pub. No.: US 2009/0174625 A1
(43) Pub. Date: Jul. 9, 2009

(54) DISPLAY DEVICE AND DRIVING METHOD THEREOF

(76) Inventors: Kyung-Wook KIM, Seoul (KR); Mi-Ae Lee, Cheonan-si (KR); Kye-Hun Lee, Cheonan-si (KR)

Correspondence Address: F. CHAU & ASSOCIATES, LLC, 130 WOODBURY ROAD, WOODBURY, NY, 11797, US

(21) Appl. No.: 12/173,994

(22) Filed: Jul. 16, 2008

(30) Foreign Application Priority Data
Jan. 8, 2008 (KR) 10-2008-0002178

(51) Int. Cl. G09G 3/20

(52) U.S. Cl. 345/55

(57) ABSTRACT

A display device includes a gate line, first, second, and third data lines arranged parallel to each other and intersecting the gate line, a first pixel connected to the gate line and the second data line and disposed between the first data line and the second data line, a second pixel connected to the gate line and the third data line and disposed between the second data line and the third data line, and an operational amplifier electrically connected to the third data line and the first data line to transmit the signal of the third data line to the first data line.

### CROSS-REFERENCE TO RELATED APPLICATION

This application claims priority to Korean Patent Application No. 10-2008-0002178 filed on Jan. 8, 2008, the entire contents of which are incorporated herein by reference.

### BACKGROUND OF THE INVENTION

(a) Technical Field

The present disclosure relates to a display device and a driving method of the same, and more particularly to a display device and a driving method of the same capable of displaying a uniform luminance according to input image signals.

(b) Discussion of the Related Art

Flat panel displays include an organic light emitting diode (OLED) display, a plasma display panel (PDP), and a liquid crystal display (LCD).

The PDP displays characters and/or images by employing plasma generated by gas discharge. The OLED display displays characters and/or images by employing electric field emission of organic materials or polymers. The liquid crystal display displays images by applying an electric field to a liquid crystal layer between two display panels and controlling the intensity of the electric field, thereby controlling the transmittance of light passing through the liquid crystal layer.

Each of the LCD and the OLED displays includes a display panel, a gate driver, a gray voltage generator, a data driver, and a signal controller. The display panel is provided with pixels including switching elements and display signal lines. The gate driver outputs a gate signal to a gate line among the display signal lines to turn on/off the switching elements of the pixels. The gray voltage generator generates a plurality of gray voltages. The data driver selects a data voltage corresponding to image data among the gray voltages to apply the data voltage to a data line among the display signal lines. The signal controller controls the display panel, the gate driver, the gray voltage generator, and the data driver.

Each driver is supplied with predetermined voltages and converts the predetermined voltages into various voltages to drive the display device. For example, the gate driver receives a gate-on voltage and a gate-off voltage and alternatively applies the gate-on and gate-off voltages to the gate line as a gate signal. The gray voltage generator receives a uniform reference voltage and divides the uniform reference voltage through a resistor to provide divided voltages to a data driver.

The liquid crystal display (LCD) includes two display panels provided with pixel electrodes and a common electrode, and a liquid crystal layer formed therebetween having a dielectric anisotropy. The pixel electrodes are in a matrix form and are connected to switching elements such as a thin film transistor (TFT) to sequentially receive data voltages per row. The common electrode is formed on the surface of the display panel, for example, the whole surface, and receives a common voltage. A pixel electrode, a common electrode, and a liquid crystal layer form a liquid crystal capacitor, and the liquid crystal capacitor is a unit constituting a pixel together with a switching element connected thereto.

In such a liquid crystal display, voltages are applied to the two electrodes to form an electric field in the liquid crystal layer, and transmittance of light passing through the liquid crystal layer is controlled by regulating the amplitude of the electric field to obtain a desired image. To prevent a degradation phenomenon caused by long application of an electric field in one direction to a liquid crystal layer, the polarity of the data voltage with respect to the common voltage is inverted for respective frames, respective rows, or respective pixels.

In the liquid crystal display where a plurality of pixels displaying the same color are arranged in a stripe shape, red pixels are disposed on the left end and blue pixels are disposed on the right end. The data lines are respectively disposed near the left and right sides of each of the pixel electrodes. For a pixel disposed on the leftmost side among the pixels, when the switching element of the pixel is disposed on the right side of the pixel, the data line is disposed only on the right side of the pixel electrode. For a pixel disposed on the rightmost side, when the switching element of the pixel is disposed on the left side of the pixel, the data line is disposed only on the left side of the pixel electrode. Therefore, the electrostatic capacitance generated between the data line and the pixel electrode are different between pixels where the data lines are disposed on both sides of the pixel electrode, and pixels where the lines are disposed on one side of the pixel electrode.

Differences between the electrostatic capacitances on the left and right sides of the pixel electrode generate changes of the pixel electrodes.

Thus, when the liquid crystal display is a normally white mode and the switching element of the pixel is disposed on the right side of the pixel the red pixels R disposed on the leftmost side of the pixels exhibit a higher luminance than that of the other pixels. When the liquid crystal display is a normally black mode and the switching element of the pixel is disposed on the right side of the pixel, the red pixels R disposed on the leftmost side of the pixels exhibit a lower luminance than that of the other pixels.

### SUMMARY OF THE INVENTION

According to an exemplary embodiment, a display device can display a uniform luminance according to input image signals.

A display device according to an exemplary embodiment of the present invention includes a gate line, first, second, and third data lines arranged parallel to each other and intersecting the gate line, a first pixel connected to the gate line and the second data line and disposed between the first data line and the second data line, a second pixel connected to the gate line and the third data line and disposed between the second data line and the third data line, and an operational amplifier respectively electrically connected the third data line and the first data line to transmit the signal of the third data line to the first data line.

The operational amplifier may include a first input terminal electrically connected to the third data line, an output terminal electrically connected to the first data line, and a second input terminal connected to the output terminal.

The gate line, the first to third data lines, and the pixel may be formed on at least one display panel, and the display device may further include a gate driver applying a gate signal to the gate line, a data driver applying a data signal to the second and third data lines, and a signal controller controlling the gate driver and the data driver.

The operational amplifier may be disposed outside the display panel.

The display device may further include a printed circuit board (PCB) disposed with the signal controller, and a flexible printed circuit film connecting the printed circuit board (PCB) and the display panel.

The operational amplifier may be disposed on one of the printed circuit board (PCB) and the flexible printed circuit film, and the flexible printed circuit film may include a first connection line for electrically connecting the operational amplifier and the first data line and a second connection line for electrically connecting the operational amplifier and the third data line.

The data driver may include a driver IC chip mounted on the flexible printed circuit film, and the first and second connection line may be separated from the driver IC chip.

The operational amplifier may be formed in the driver IC chip.

The flexible printed circuit film may include a connection terminal including first, second, and third connection terminals, and an output terminal connected to the second and third data lines, and the first connection terminal is connected to the operational amplifier and is connected to the first connection line through the printed circuit board (PCB), while the second connection terminal is connected to the operational amplifier and is connected to the second connection line through the printed circuit board (PCB).

The first pixel may include a switching element having a control terminal connected to the gate line, an input terminal connected to the second data line, and an output terminal outputting a data signal input from the second data line, and the first connection line is formed on the same layer as the input terminal and output terminal, while the second connection line is formed on the same layer as the control terminal.

The switching element may be disposed on the right side of the first pixel, and the first data line may be disposed on a leftmost side among data lines.

The switching element may be disposed on the left side of the first pixel, and the first data line may be disposed on a rightmost side among data lines.

The display device may further include a voltage generator IC chip generating a voltage to the display device and mounted on the printed circuit board (PCB), wherein the operational amplifier may be formed in the voltage generator IC chip.

A data signal applied to the second data line and a data signal applied to the third data line may have opposite voltage polarities.

According to an exemplary embodiment of the present invention, a driving method of a display device including a gate line, first, second, and third data lines arranged parallel to each other and intersecting the gate line, a first pixel connected to the gate line and the second data line and disposed between the first data line and the second data line, and a second pixel connected to the gate line and the third data line and disposed between the second data line and the third data line, the driving method includes applying a first data signal to the second data line, applying a second data signal to the third data line, preventing a load of the second data line by the third data line, and transmitting the first data signal to the third data line.

The gate line, the first to third data lines, and the pixel may be formed on at least one display panel, and the preventing of the load of the second data line may be executed outside the display panel. The first data signal and the second data signal may have opposite polarities.

According to an exemplary embodiment of the present invention, a liquid crystal display and a driving method thereof can prevent a luminance imbalance without increasing a load of a data line and a delay of the data signal.

### BRIEF DESCRIPTION OF THE DRAWINGS

Exemplary embodiments of the present invention can be understood in more detail from the following descriptions taken in conjunction with the accompanying drawings, wherein:

FIG. 1 is a block diagram of a display device according to an exemplary embodiment of the present invention;

FIG. 2 is a layout view showing a data driver, a display panel unit, and a PCB according to an exemplary embodiment of the present invention;

FIG. 3 is an equivalent circuit diagram of one pixel in a liquid crystal display according to an exemplary embodiment of the present invention;

FIG. 4 is a view schematically showing some pixels and data lines adjacent to the pixels in a display device according to an exemplary embodiment of the present invention; and

FIG. 5 is a layout view showing a data driver, a display panel unit, and a PCB according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. When it is described that an element is “coupled” to another element, the element may be directly coupled to the other element or electrically coupled to the other element through a third element.

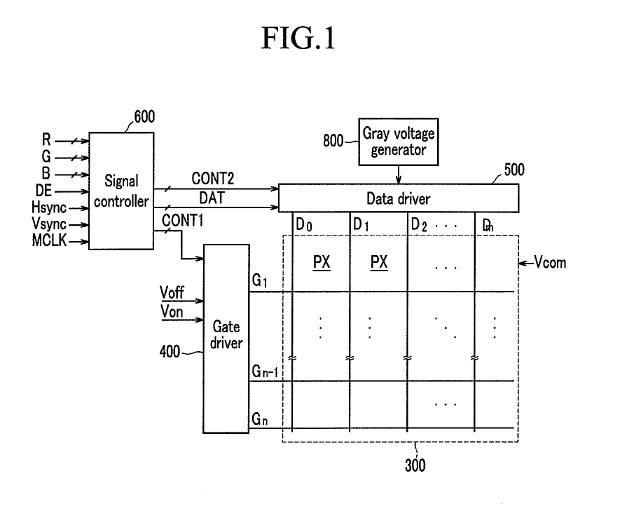

A display device according to an exemplary embodiment of the present invention is described with reference to FIG. 1 to FIG. 3.

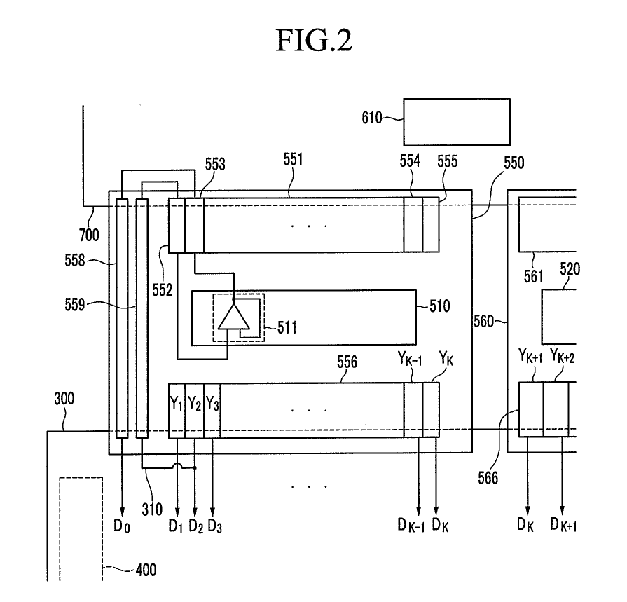

FIG. 1 is a block diagram of a display device according to an exemplary embodiment of the present invention. FIG. 2 is a view showing a display device according to an exemplary embodiment of the present invention.

Referring to FIG. 1, a liquid crystal display according to an exemplary embodiment of the present invention includes a display panel unit 300, a gate driver 400, a data driver 500, and a signal controller 600.

Referring to FIG. 1, the display panel unit 300 includes a plurality of signal lines G₁-Gₙ and D₀-Dₘ, and a plurality of pixels PX connected thereto and arranged substantially in a matrix.

The signal lines G₁-Gₙ and D₀-Dₘ include a plurality of gate lines G₁-Gₙ transmitting gate signals (also referred to as “scanning signals”), and a plurality of data lines D₀-Dₘ transmitting data signals.

The gate lines G₁-Gₙ extend substantially in a row direction and substantially parallel to each other. The data lines D₀-Dₘ extend substantially in a column direction and substantially parallel to each other.

Each pixel column is disposed with two neighboring data lines D₀-Dₘ. Data lines D₁-Dₘ are connected to the pixels PX, and referred to as normal data lines. The data line D₀ disposed on the leftmost side is not connected to a pixel PX, and is referred to as an additional data line. In an exemplary embodiment, the data line disposed on the rightmost side may be the additional data line that is not connected to the pixel and the remaining data lines may be normal data lines.

Each pixel PX includes a luminance control element (not shown) and a switching element (not shown). The switching elements are connected to the gate lines G₁-Gₙ and the normal data lines D₁-Dₘ, and transmit data signals from the data lines D₀-Dₘ to the pixels PX according to the gate signals from the gate lines G₁-Gₙ.

Each luminance control element includes a pair of field generating electrodes and an electric-optical active layer formed therebetween. One field generating electrode is connected to an individual pixel PX. The other field generating electrode is connected to all of the pixels PX. The former is referred to as a “pixel electrode” and the latter is referred to as a “common electrode”. The pixel electrode may receive a data signal or an electrode signal derived from the data signal, and the common electrode may be applied with a common voltage Vcom.

The electric-optical active layer converts the electric signal applied to the pixel electrode into an optical signal. The display device according to an exemplary embodiment of the present invention includes a liquid crystal layer as the electric-optical active layer.

The pixel electrode is formed substantially in the region defined by the gate lines G₁-Gₙ and the data lines D₀-Dₘ, and the pixel electrode is formed adjacent to the gate lines G₁-Gₙ and the data lines D₀-Dₘ. Therefore, parasitic capacitors are generated between the pixel electrodes, and the gate lines G₁-Gₙ and the data lines D₀-Dₘ.

Referring to FIG. 1, the data lines D₀-Dₘ are disposed on both sides of each pixel including each pixel at the leftmost side such that the parasitic capacitance generated between the first pixel column and two data lines D₀ and D₁ adjacent thereto is almost the same as the parasitic capacitance generated between the other pixel columns and the data lines D₁ and D₂ adjacent thereto.

The gate driver 400 is connected to the gate lines G₁-Gₙ of the display panel unit 300, and applies the gate signals, which are combinations of a gate-on voltage Von and a gate-off voltage Voff, to the gate lines G₁-Gₙ.

The data driver 500 is connected to the data lines D₀-Dₘ of the display panel unit 300. The data driver 500 generates and applies data signals to the data lines D₀-Dₘ. The data signals may be voltage signals.

The signal controller 600 controls the gate driver 400 and the data driver 500.

Referring to FIG. 2, the display device according to an exemplary embodiment of the present invention may include a printed circuit board (PCB) 700, flexible printed circuit films 550 and 560, driver IC chips 510 and 520, and the display panel unit 300.

In an exemplary embodiment, the gate driver 400, the switching elements of the pixels PX, and the signal lines G₁-Gₙ and D₀-Dₘ can be integrated on the display panel unit 300. The signal controller 600 is mounted on the PCB 700 in a form of an IC chip 610. The data driver 500 is mounted on the flexible printed circuit film 550 and 560 in a form of the plurality of driver IC chips 510 and 520.

Each of the driving apparatuses 400, 500, and 600 may be integrated and mounted on the display panel unit 300 in at least one IC chip form, or may be mounted on a flexible printed circuit film (not shown) and then attached to the display panel unit in a tape carrier package (TCP) form. In an exemplary embodiment, all driving apparatuses 400, 500, and 600 may be integrated into a single chip.

In an exemplary embodiment, a wiring structure for an electrical connection between the PCB 700 and the driver IC chips 510 and 520, between the driver IC chips 510 and 520 and the display panel unit 300, and between the PCB 700 and the display panel unit 300 is formed in the flexible printed circuit films 550 and 560.

Connecting terminals 551 and 561 electrically connect the PCB 700 and the driver IC chips 510 and 520 with each other. Output terminals 556 and 566 electrically connect the driver IC chips 510 and 520 and the display panel unit 300 with each other.

The connecting terminals 551 and 561 include a plurality of connecting terminals. In an exemplary embodiment, the connection terminals are used to connect the signal controller 600 of the PCB 700 and the driver IC chips 510 and 520. Referring to FIG. 2, connecting terminals 552, 553, 554, and 555 are formed on the flexible printed circuit film 550 and disposed on the leftmost side.

The output terminals 556 and 566 include a plurality of output terminals Y₁, Y₂, . . . , Yₖ, Yₖ₊₁, . . . , and connect the driver IC chips 510 and 520 and the normal data lines D₁, D₂, . . . , Dₖ, Dₖ₊₁, . . . with each other.

Referring to FIG. 2, the flexible printed circuit films 550 and 560 may also include a wiring structure for directly connecting the display panel unit 300 and the PCB 700 without passing the driver IC chips 510 and 520, and connecting lines 558 and 559 formed on the flexible printed circuit film 550 and disposed on the leftmost side. The connecting line 558 is connected to the additional data line D₀ of the display panel unit 300. The connecting line 558 is connected to the connection terminal 553 through the PCB 700. The connecting line 559 is electrically connected to one of the normal data lines D₁-Dₘ of the display panel unit 300, for example the second normal data line D₂, and is connected to the connecting terminal 552 through the PCB 700.

The connection between the connecting line 559 and the data line D₂ is formed through a conductive line 310 of the display panel unit 300. The gate lines G₁-Gₙ and the data lines D₀-Dₘ intersect each other in the display panel unit 300 such that the gate lines G₁-Gₙ and the data lines D₀-Dₘ are disposed at different layers via an insulating layer (not shown) formed therebetween. In an exemplary embodiment, the conductive line 310 crosses the first normal data line D₁ such that the conductive line 310 may be formed at the same layer as the gate lines G₁-Gₙ. In an exemplary embodiment, the conductive line 310 may be formed at a different layer from all the gate lines G₁-Gₙ and the data lines D₀-Dₘ.

The driver IC chips 510 and 520 generate data voltages according to the control of the signal controller 600 to apply the data voltages to the data lines D₁, D₂, . . . , Dₖ, Dₖ₊₁, . . . . The driver IC chip 510 may further include an operational amplifier 511 for applying the signal to the additional data line D₀.

The operational amplifier 511 includes two input terminals and one output terminal. The output terminal of the operational amplifier 511 is connected to the connecting terminal 553, and one of the two input terminals of the operational amplifier 511 is connected to the connecting terminal 552 and the other is connected to the output terminal.

In an exemplary embodiment, the data signals applied to the data line D₂ from the driver IC chip 510 are transmitted to the operational amplifier 511 through the connecting terminal 552. The operational amplifier 511 outputs the input signal as an output signal. The output signal is applied to the additional data line D₀ through the connection terminal 553.

The data lines D₀ and D₁ are disposed on both sides of a pixel column such that the pixel column disposed at the leftmost side forms substantially the same parasitic capacitance as that of other pixel columns. The data signal applied to the data lines D₀ and D₁ disposed on both sides of the pixel column positioned at the leftmost side is the same as the data signal applied to the data lines D₁ and D₂ disposed on both sides of the pixel column positioned at the second from the left side. As such the luminance changes of the pixels PX are generated due to the change of the data signal in the two pixel column. Therefore, the luminance imbalance due to the difference of the parasitic capacitance and the signal change is reduced between the pixel columns.

In an exemplary embodiment, the operational amplifier 511 divides the impedance of the input terminal and the impedance of the output terminal such that the impedance of the second normal data line D₂ is not increased. If the operational amplifier 511 is not formed, the impedance of the second normal data line D₂ is increased such that a delay of the data signal is generated, and image distortion and deterioration of the display quality according to the image distortion may be generated. For example, serious deterioration of the display quality may be generated in a liquid crystal display of a large size.

When an operational amplifier is disposed on both sides of the chip for repairing the data lines D₁-Dₘ, and when a disconnection is generated in the central portion of the data lines D₁-Dₘ, the data signal is not transmitted to the data lines D₁-Dₘ next to the disconnected position. Thus, a repairing line connected to the end of the disconnected data line is formed on the edge of the display panel unit 300 and the data signal is transmitted to the data lines next to the disconnected position through the repairing line. In an exemplary embodiment, the data signal is applied to the repairing line through the operational amplifier such that the signal delay generated by the detour through the repairing line is reduced.

Therefore, the operational amplifier included for repairing the IC chip may be used in an exemplary embodiment of the present invention such that an additional design is not necessary.

When the additional data line D₀ is disposed on the right side rather than the left side, the data signal may be applied to the additional data line D₀ through the connection terminal 554 and 555 on the right side of the flexible printed circuit film 550 and an operational amplifier disposed on the right side of the driver IC chip 510. In an exemplary embodiment, the signal applied to the second normal data line Dₘ₋₁ may be applied to the additional data line D₀.

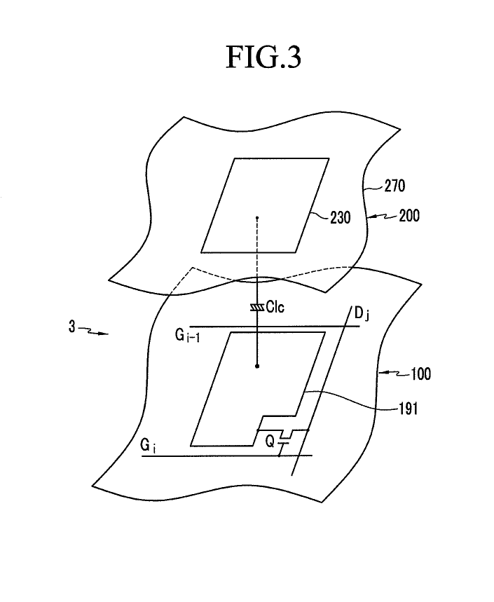

Referring to FIG. 3, the display panel unit 300 of the liquid crystal display includes a lower panel 100 and an upper panel 200 facing each other, and a liquid crystal layer 3 formed between the two display panels 100 and 200.

Each pixel PX of the liquid crystal display, e.g., a pixel (PX) connected to an i-th (i=1, 2, . . . , n) gate line (Gᵢ) and a j-th (j=1, 2, . . . , m) data line (Dⱼ), includes a switching element Q connected to the signal lines (Gᵢ, Dⱼ), and a liquid crystal capacitor Clc and a storage capacitor Cst connected to the switching element Q. In an exemplary embodiment, the storage capacitor Cst may be omitted.

The switching element Q is a three terminal element, such as, for example, a thin film transistor, provided to the lower panel 100. A control terminal of the switching element Q is connected to the gate line Gᵢ, an input terminal of the switching element Q is connected to the data line Dⱼ, and an output terminal of the switching element Q is connected to the liquid crystal capacitor Clc and the storage capacitor Cst.

The liquid crystal capacitor Clc has two terminals of a pixel electrode 191 of the lower panel 100 and a common electrode 270 of the upper panel 200. The liquid crystal layer 3 formed between the two electrodes 191 and 270 serves as a dielectric material. The pixel electrode 191 is connected to the switching element Q, and the common electrode 270 is formed on the entire surface of the upper panel 200. A common voltage Vcom is applied to the common electrode 270. In an exemplary embodiment, the common electrode 270 may be provided on the lower panel 100. In this case, at least one of the two electrodes 191 and 270 can be formed in a linear or bar shape.

The storage capacitor Cst, which assists the liquid crystal capacitor Clc, has a separate signal line (not shown) and the pixel electrode 191 provided on the lower panel 100 to overlap an insulator interposed therebetween. A predetermined voltage such as the common voltage Vcom is applied to the separate signal line. In an exemplary embodiment, the storage capacitor Cst may be formed by the pixel electrode 191 and the overlying previous gate line Gi-1 arranged to overlap each other through the insulator.

For color display, each pixel PX displays one of three primary colors (spatial division) or each pixel PX alternately displays the three primary colors (temporal division) as time passes. A desired color is recognized by a spatial or temporal sum of the primary colors. For example, the primary colors are three primary colors of red, green, and blue. FIG. 3 shows a color filter 230 displaying one of primary colors on a region of an upper panel 200 corresponding to a pixel electrode 191 by each of the pixels as an example of spatial division. In an exemplary embodiment, the color filter 230 may be provided on or under the pixel electrode 191 of the lower panel 100. In a stripe arrangement, color filters 230 displaying the same color may be arranged according to the columns of the pixels PX, and color filters 230 displaying different colors may be sequentially arranged according to the rows of the pixels PX. In an exemplary embodiment, the color filters 230 may be arranged in different ways.

In an exemplary embodiment, at least one polarizer (not shown) for polarizing light is attached to the outside surface of the display panel unit 300.

The signal controller 600 receives input image signals R, G, and B and an input control signal for controlling the display of the input image signals R, G, and B from an external graphics controller (not shown). The input image signals R, G, and B include luminance information of each pixel PX, and the luminance has grays of a given number, for example, 1024 (=2¹⁰), 256 (=2⁸), or 64 (=2⁶). The input control signal includes, for example, a vertical synchronization signal Vsync, a horizontal synchronizing signal Hsync, a main clock signal MCLK, and a data enable signal DE.

The signal controller 600 processes input image signals R, G, and B under the operating conditions of the liquid crystal panel assembly 300 and the data driver 500 on the basis of the input image signals R, G, and B and the input control signal. The signal controller 600 generates a gate control signal CONT1 and a data control signal CONT2, transmits the gate control signal CONT1 to a gate driver 400, and then outputs the data control signal CONT2 and the processed image signal DAT to the data driver 500.

The gate control signal CONT1 includes a scanning start signal STV for directing the start of scanning and at least one clock signal for controlling the output timing of a gate-on voltage Von. The gate control signal CONT1 may include an output enable signal OE for defining the duration of the gate-on voltage Von.

The data control signal CONT2 includes a horizontal synchronization start signal STH for notifying of a beginning of digital image signal DAT transmission to one column of pixels, and a load signal LOAD and a data clock signal HCLK for ordering load of an analog data signal to the data lines D₁-Dₘ. The data control signal CONT2 can include an inversion signal RVS inverting a voltage polarity of the data voltage for the common voltage Vcom. The data signal polarity denotes the voltage polarity of the data signal for the common voltage.

The data driver 500 receives a digital image signal DAT for a column of pixels, and converts the digital image signal DAT to an analog data signal according to the data control signal CONT2 from the signal controller 600. Then, the analog data signal is supplied to corresponding data lines D₁-Dₘ.

The gate driver 400 supplies a gate-on voltage Von to gate lines G₁-Gₙ according to a gate control signal CONT1 from the signal controller 600, thereby turning on a switching element Q connected to the gate lines G₁-Gₙ. Then, the data signal supplied to the data lines D₁-Dₘ is supplied to a corresponding pixel PX through the turned-on switching element Q such that each pixel PX displays a luminance corresponding to the luminance information included to input image signals R, G, and B.

In an exemplary embodiment, the difference between the voltage of a data signal supplied to a pixel PX and the common voltage Vcom is a charge voltage of a liquid crystal capacitor Clc, which is a pixel voltage. Liquid crystal molecules vary their arrangement according to the level of the pixel voltage. The polarization of light passing the liquid crystal layer 3 varies according to the variation of the liquid crystal molecule arrangement. Such a polarization variation is a transmittance variation of light by a polarizer attached at the display panel assembly 300, and the pixel PX displays luminance expressing the gray of the image signal DAT.

By repeating the above-described operation in a unit of 1 horizontal period 1H that is equivalent to one cycle of a horizontal synchronizing signal Hsync and a data enable signal DE, the gate-on voltage Von is sequentially provided to all gate lines G₁-Gₙ and an image of one frame is displayed by supplying the data signals to all pixels PX.

For example, in the case of the liquid crystal display, the state of the inversion signal RVS applied to the data driver 500 is controlled such that the polarity of the data signal voltage applied to each pixel PX is opposite to the polarity of the data signal voltage in the previous frame (“frame inversion”). The polarity of the data signal applied to one data line may be inverted in the same frame according to the characteristic of the inversion signal RVS (for example, row inversion and dot inversion). The polarities of the data signals applied to a row of pixels may be different from each other (for example, column inversion and dot inversion).

In the column inversion and the dot inversion, the polarities of the data voltages applied to the adjacent data line are opposite to each other. Therefore, one of two data lines adjacent to each pixel column from the second pixel column to the final pixel column is applied with the positive voltage, and the other is applied with the negative voltage. In an exemplary embodiment, the voltage applied to the additional data line D₀ is determined as the data voltage applied to the second normal data line D₂, not the data voltage applied to the first normal data line D₁ closest to the additional data line D₀. As such, one of two data lines D₀ and D₁ is applied with the positive voltage and the other data line is applied with the negative voltage in the first pixel column, as in the other pixel columns.

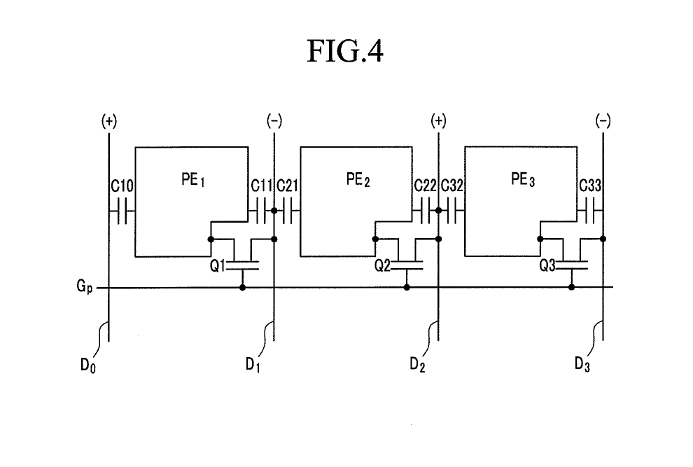

FIG. 4 is a view schematically showing some pixels and data lines adjacent to the pixels in the display device according to an exemplary embodiment of the present invention.

In FIG. 4, PEₚ and Qₚ (p=1, 2, and 3) respectively represent a pixel electrode and a switching element of the pixel in the p-th pixel array, D_{q} (q=0, 1, 2, and 3) represents the q-th data line, and C_{pq} represents the parasitic capacitance generated between the pixel electrode of the p-th pixel array and the q-th data line. C10, C21, and C32 may be the same with each other, and C11, C22, and C33 may be substantially the same with each other. C10, C21, C32, C11, C22, and C33, may be substantially the same with each other.

In the column inversion or the dot inversion, if the negative voltages are applied to the first and third normal data lines D₁ and D₃, the positive voltage is applied to the second normal data line D₂ such that the positive voltage is also applied to the additional data line D₀. In the next horizontal period, the positive voltages are applied to the first and third normal data lines D₁ and D₃, and the negative voltage is applied to the second normal data line D₂ and the additional data line D₀. As such, the polarities of the voltages applied to the data lines D₀-Dₘ are subsequently changed.

If the switching elements Q1, Q2, and Q3 are turned off such that the pixel electrodes PE1, PE2, and PE3 become floated, the voltages of the pixel electrodes PE1, PE2, and PE3 are also changed according to the change of the voltage of the neighboring data lines D₀, D₁, D₂, and D₃ connected through the parasitic capacitor. In an exemplary embodiment, the change variations of the voltages of the pixel electrode PE1, PE2, and PE3 depend on the parasitic capacitance and the voltage variations of the data lines D₀, D₁, D₂, and D₃.

For example, if the voltage of the first normal data line D₁ is changed from V1i to V1f and the voltage of the additional data line D₀ is changed from V2i to V2f, the voltage variation ΔVp of the first pixel electrode PE1 is given by the following Equation 1:

ΔVp=C11(V1f−V1i)/Ct+C10(V2f−V2i)/Ct. (Equation 1)

Here, Ct is the total electrostatic capacitance of the pixel electrode PE1.

In an exemplary embodiment, the voltage polarity of the additional data line D₀ is opposite to the voltage polarity of the first normal data line D₁ such that the signs of (V1f−V1i) and (V2f−V2i) are opposite with each other. Therefore, the voltage variation ΔVp of the pixel electrode PE1 is reduced compared with the case in which the additional data line D₀ is not formed, that is, C10 is 0.

If the voltage polarity of the additional data line D₀ is the same as the voltage polarity of the first normal data line D₁, the voltage variation ΔVp of the pixel electrode PE1 is increased.

If the voltage Vd of the first normal data line is larger than 0, and is changed to −Vd, and the voltage of the second normal data line is changed from −Vd to Vd, the voltage variation ΔVp of the pixel electrode PE1 is given by the following Equation 2:

$$\begin{matrix}Δ Vp = C 11 [ Vd - ( - Vd ) ] / Ct + C 10 ( - Vd - Vd ) / Ct \\ = ( 2 Vd / Ct ) ( C 11 - C 10 )\end{matrix} . \qquad ( Equation 2 )$$

If the data voltage is converted and returned to the original value, the voltage of the pixel electrode PE1 is returned to the original value. Since the voltage change is periodically repeated, if the root mean square value is obtained as in Equation 3, the effective voltage variation ΔVrp is given by the following Equation 3:

ΔVrp=Vd(C11−C10)/Ct. (Equation 3)

As shown in Equation 3, if C11 and C10 are the same with each other, the effective voltage variation ΔVrp does not exist, but if the difference therebetween is increased, the effective voltage variation ΔVrp becomes large. Therefore, in an exemplary embodiment, the parasitic capacitance generated by two data lines D₀ and D₁ adjacent to the pixel electrode PE1 are the same.

For example, if the voltage of the second normal data line D₂ is changed from Vd to −Vd (which is equal to the voltage change of the additional data line), and the voltage of the third normal data line D₃ is changed from −Vd to Vd, the effective voltage variation ΔVrp2 of the second pixel electrode PE2 and the effective voltage variation ΔVrp3 of the third pixel electrode PE3 are given by the following Equation 4:

ΔVrp2=Vd(C22−C21)/Ct and

ΔVrp3=Vd(C33−C32)/Ct. (Equation 4)

As shown in Equation 4, the effective voltage variation is proportional to the difference of the magnitude of the parasitic capacitance, and because the pixels PE1, PE2, and PE3 and the data lines D₀-D₃ are designed to be substantially the same, the voltage variation of the pixel electrodes according to the voltage change of the data lines D₀-D₃ is the same in all pixels.

Accordingly, according to exemplary embodiments, the luminance imbalance due to the difference of the parasitic capacitances and the difference of the voltage changes between the pixel columns is reduced.

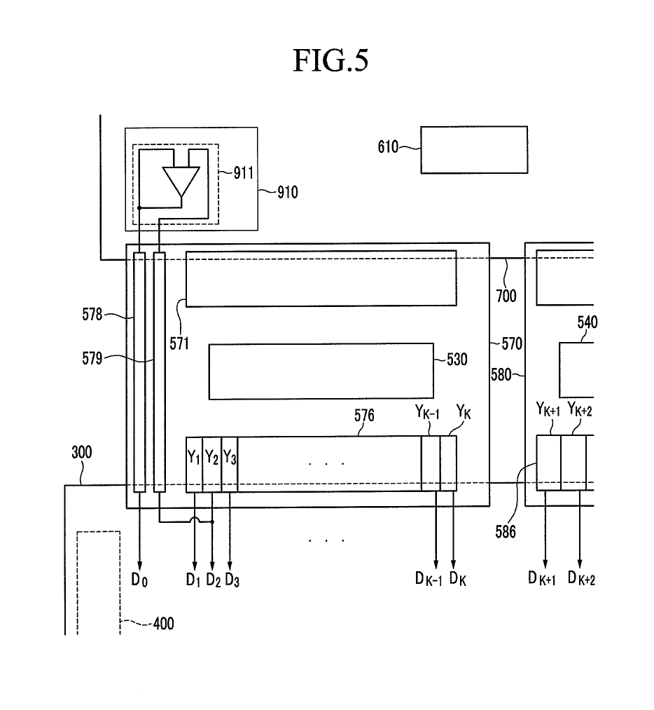

A display device according to an exemplary embodiment of the present invention is described with reference to FIG. 5 and FIG. 1.

FIG. 5 is a layout view showing a data driver 500, a display panel unit 300, and a PCB 700 according to an exemplary embodiment of the present invention.

In an exemplary embodiment, a display device includes a display panel unit 300, a printed circuit board (PCB) 700, a flexible printed circuit film 570, and a driving circuit chip 530.

The display panel unit 300 may include pixels (not shown), gate lines (not shown), and data lines (D₀-Dₘ).

The driver IC chip 530 is mounted on the flexible printed circuit film 570. A connecting terminal 571, an output terminal 576, and connection lines 578 and 579 are formed on the flexible printed circuit film 570. The output terminal 576 includes a plurality of output terminals Y₁, Y₂, . . . , Yₖ, Yₖ₊₁, . . . .

A voltage generator IC chip 910 and a signal controller IC chip 610 are mounted on a printed circuit board (PCB) 700.

The voltage generator IC chip 910, which is a DC-DC converter, receives a voltage from a power supply device (not shown) and converts the voltage into a voltage used for the operation of the display device. The voltage generator IC chip 910 includes an operational amplifier 911. One input terminal of the operational amplifier 911 is electrically connected to one of the normal data lines D₁-Dₘ of the display panel unit 300, for example, the second normal data line D₂, through the connection line 579. The other input terminal of the operational amplifier 910 is connected to the output terminal, and the output terminal is connected to the additional data line D₀ through the connection line 578.

Referring to FIG. 2, the operational amplifier 511 can be formed in the driver IC chips 510 and 520. In an exemplary embodiment, the operational amplifier 911 can be formed in the voltage generator IC chip 910. The connection relationship is changed according to the position of the operational amplifier 911.

Because some voltage generator IC chips may include a plurality of operational amplifiers, it may not be necessary to additionally design an operational amplifier to practice the embodiments of the present invention.

In an exemplary embodiment, the operational amplifier may be disposed at a different position.

Although the illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A display device comprising:
a gate line;
first, second, and third data lines arranged parallel to each other and intersecting the gate line;
a first pixel connected to the gate line and the second data line and disposed between the first data line and the second data line;
a second pixel connected to the gate line and the third data line and disposed between the second data line and the third data line; and
an operational amplifier electrically connected to the third data line and the first data line to transmit the signal of the third data line to the first data line.

2. The display device of claim 1, wherein
the operational amplifier includes a first input terminal electrically connected to the third data line, an output terminal electrically connected to the first data line, and a second input terminal connected to the output terminal.

3. The display device of claim 2, wherein
the gate line, the first to third data lines, and the pixels are formed on at least one display panel.

4. The display device of claim 3, wherein the display device further includes:
a gate driver applying a gate signal to the gate line;
a data driver applying a data signal to the second and third data lines; and
a signal controller controlling the gate driver and the data driver.

5. The display device of claim 4, wherein
the operational amplifier is disposed outside the display panel.

6. The display device of claim 5, further comprising:
a printed circuit board (PCB) disposed with the signal controller; and
a flexible printed circuit film connecting the printed circuit board (PCB) and the display panel.

7. The display device of claim 6, wherein:
the operational amplifier is disposed on one of the printed circuit board (PCB) and the flexible printed circuit film; and
the flexible printed circuit film includes a first connection line for electrically connecting the operational amplifier and the first data line and a second connection line for electrically connecting the operational amplifier and the third data line.

8. The display device of claim 7, wherein:
the data driver includes a driver IC chip mounted on the flexible printed circuit film; and
the first and second connection line are separated from the driver IC chip.

9. The display device of claim 8, wherein
the operational amplifier is formed in the driver IC chip.

10. The display device of claim 9, wherein
the flexible printed circuit film includes:
a connection terminal including first, second, and third connection terminals; and
an output terminal connected to the second and third data lines,
wherein the first connection terminal is connected to the operational amplifier and is connected to the first connection line through the printed circuit board (PCB), and
the second connection terminal is connected to the operational amplifier and is connected to the second connection line through the printed circuit board (PCB).

11. The display device of claim 7, wherein
the first pixel includes:
a switching element having a control terminal connected to the gate line, an input terminal connected to the second data line, and an output terminal outputting a data signal input from the second data line; and
the first connection line is formed on a same layer as the input terminal and the output terminal, and the second connection line is formed on a same layer as the control terminal.

12. The display device of claim 11, wherein the switching element is disposed on a right side of the first pixel, and the first data line is disposed on a leftmost side among data lines.

13. The display device of claim 11, wherein
the switching element is disposed on a left side of the first pixel, and the first data line is disposed on a rightmost side among data lines.

14. The display device of claim 7, further comprising
a voltage generator IC chip generating a voltage to the display device, the voltage generator IC chip mounted on the printed circuit board (PCB),
wherein the operational amplifier is formed in the voltage generator IC chip.

15. The display device of claim 2, wherein
the data signal applied to the second data line and the data signal applied to the third data line have opposite voltage polarities.

16. A driving method of a display device including a gate line, first, second, and third data lines arranged parallel to each other and intersecting the gate line, a first pixel connected to the gate line and the second data line and disposed between the first data line and the second data line, and a second pixel connected to the gate line and the third data line and disposed between the second data line and the third data line, the method comprising:
applying a first data signal to the second data line;
applying a second data signal to the third data line;
preventing a load of the second data line, the load generated by the third data line; and transmitting the first data signal to the third data line.

17. The driving method of claim 16, wherein
the gate line, the first to third data lines, and the pixel are formed on at least one display panel, and
the preventing the load of the second data line is executed outside the display panel.

18. The driving method of claim 16, wherein
the first data signal and the second data signal have opposite polarities.

19. A display device comprising:
a display panel unit including at least a pixel, a gate line, and first, second and third data lines, wherein the first, second and third data lines are formed in sequence;
a printed circuit board (PCB) including a voltage generator IC chip receiving a first voltage and converting the first voltage into a second voltage used for an operation of the display panel unit, the voltage generator IC chip including an operation amplifier; and
a flexible printed circuit film, including a driving circuit chip, a connecting terminal, an output terminal, and first and second connection lines,
wherein a first input terminal of the operational amplifier is connected to the third data line through the first connection line, and a second input terminal of the operational amplifier is connected to the first data line through the second connection line.

20. The display device of claim 19, further including a signal controller IC chip mounted on the printed circuit board (PCB).
